(19) United States
(12) Patent Application Publication
(10) Pub. No.: US 2023/0039999 A1
(43) Pub. Date: Feb. 9, 2023

(54) SYSTEM AND METHOD FOR DATA WAREHOUSE STORAGE CAPACITY OPTIMIZATION BASED ON USAGE FREQUENCY OF DATA OBJECTS

(71) Applicant: Bank of America Corporation, Charlotte, NC (US)

(72) Inventors: Suki Ramasamy, Chennai (IN); Sukanya Venkatesan, Chennai (IN); Ashwin Kumar Yeramalla, Secunderabad (IN); Bhuvaneswari Govindarajan, Chennai (IN); Arunkumar Somasundaram, Coimbatore (IN)

(21) Appl. No.: 17/395,963

(22) Filed: Aug. 6, 2021

(51) Int. Cl. G06F 12/0811; G06F 16/245

(52) U.S. Cl. CPC G06F 12/0811; G06F 16/245; G06F 2212/1024

(57) ABSTRACT

A system for optimizing memory utilization receives a query statement that indicated to retrieve data objects. For a first data object, the system determines whether the first data object is stored in a high-grade data repository or a low-grade data repository. The system determines whether a recent usage frequency of the first data object exceeds a usage frequency threshold. If the system determines that the first data object is stored in the high-grade data repository and that the recent usage frequency is less than the usage frequency threshold, the system moves the first data object to the low-grade data repository. If the system determines that the first data object is stored in the low-grade data repository and that the recent usage frequency is more than the usage frequency threshold, the system moves the first data object to the high-grade data repository. The system outputs the data objects.

### TECHNICAL FIELD

The present disclosure relates generally to database management, and more specifically to system and method for data warehouse storage capacity optimization based on usage frequency of data objects.

### BACKGROUND

Data warehouses and data repositories are used to store data objects. In some cases, a set of data objects may be used less often over time. The presence of unused or rarely used data objects in a data repository becomes unnecessary overhead in the data repository because the maintenance of the unused or rarely used data objects requires processing and memory resources. In addition, unused or rarely used data objects occupy the storage capacity of the data repository which reduces the efficiency in storage capacity utilization of the data repository. Current technology is not configured to provide a reliable and efficient solution for data repository storage capacity optimization based on the usage frequency of data objects.

### SUMMARY

The system described in the present disclosure is particularly integrated into a practical application of optimizing memory utilization associated with data warehouses or data repositories based on the usage frequency of stored data objects.

A high-grade data repository is used to store data objects. Examples of the high-grade data repository include, but are not limited to, a high-speed database, high-speed storage cloud, and a high-speed server. The high-grade data repository may be associated with a processing resource that is capable of retrieving data objects faster than a low-grade data repository. Examples of the low-grade data repository include, but are not limited to, low-speed archival storage and a file storage system.

Users can request to retrieve data objects from the high-grade data repository by executing query statements. In some cases, a set of data objects stored in the high-grade data repository may not be requested to be retrieved frequently. For example, retrieval requests (and/or usage frequencies) associated with the set of data objects may decrease over time. Unused or rarely used data objects in the high-grade data repository occupy the storage capacity of the high-grade data repository and cause overhead for database operations, and slow down the database operations, such as sorting, retrieving, and updating data objects. Thus, it is not desired to keep unused or rarely used data objects in the high-grade data repository.

This disclosure contemplates systems and methods for optimizing memory utilization associated with data warehouses or data repositories based on the usage frequency of stored data objects. The disclosed system determines whether a data object is stored in the high-grade data repository or the low-grade data repository. The disclosed system also determines the recent usage frequency associated with the data object. If the disclosed system determines that the data object is stored in the high-grade data repository and that the recent usage frequency associated with the data object is less than a usage frequency threshold, the disclosed system moves the data object from the high-grade data repository to the low-grade data repository. If the disclosed system determines that the data object is stored in the low-grade data repository and that the recent usage frequency associated with the data object is more than the usage frequency threshold, the disclosed system moves the data object from the low-grade data repository to the high-grade data repository.

In this manner, the disclosed system optimizes the storage capacity utilization of the high-grade data repository, e.g., by relocating unused and rarely used data objects to another data repository, and thus reducing overhead in database operations and increasing data retrieval speed. In other words, the disclosed system dynamically toggles or moves data objects between the high-grade data repository and the low-grade data repository based on the recent usage frequency of the data objects.

In one embodiment, a system for optimizing memory utilization based on the usage frequency of data objects comprises a processor, a memory, a low-grade data repository, and a high-grade data repository. The processor receives a query statement, where the query statement indicates to retrieve one or more data objects. For a first data object from among the one or more data objects, the processor determines whether the first data object is stored in a high-grade data repository or a low-grade data repository. The processor determines a first recent usage frequency associated with the first data object in a particular time period. The processor determines whether the first recent usage frequency exceeds a usage frequency threshold. In response to determining that the first data object is stored in the high-grade data repository and that the first recent usage frequency does not exceed the usage frequency threshold, the processor moves the first data object from the high-grade data repository to the low-grade data repository. In response to determining that the first data object is stored in the low-grade data repository and that the first recent usage frequency exceeds the usage frequency threshold, the processor moves the first data object from the low-grade data repository to the high-grade data repository. The processor outputs a result set that comprises the one or more data objects by retrieving the one or more data objects from one or both of the low-grade data repository and the high-grade data repository. The memory is operably coupled to the processor. The memory is operable to store the query statement. The low-grade data repository is communicatively coupled with the processor and the memory. The low-grade data repository is configured to store data objects associated with usage frequencies less than the usage frequency threshold. The high-grade data repository is communicatively coupled with the processor, the memory, and the low-grade data repository. The high-grade data repository is configured to store data objects associated with usage frequencies more than the usage frequency threshold.

The disclosed system provides several practical applications and technical advantages, which include: 1) technology that optimizes storage capacity associated with a data repository based on analyzing usage frequencies and retrieval requests of data objects stored in the data repository; 2) technology that dynamically toggles or moves data objects between a high-grade data repository and a low-grade data repository based on analyzing usage frequencies and retrieval requests of data objects stored in the low-grade data repository and the high-grade data repository; 3) technology that predicts the future usage frequency and retrieval requests of a data object based on detecting the trend in the historical usage frequency and retrieval requests; 4) technology that moves the data object to the low-grade data repository in response to determining that the usage frequency and retrieval request of the data object is decreasing over time, and/or it is less than the usage frequency threshold; and 5) technology that moves the data object to the high-grade data repository in response to determining that the usage frequency and retrieval request of the data object is increasing over time, and/or it is more than the usage frequency threshold.

As such, the disclosed system may be integrated into a practical application of improving the current data processing, data retrieval, and database management technologies. For example, the disclosed system improves the speed of the data retrieval process by reducing the overhead that is due to the presence of unused or rarely used data objects in the high-grade data repository.

This, in turn, provides an additional practical application of improving the underlying operations of the high-grade data repository. For example, by reducing overhead in the high-grade data repository, the discloses system improves databases operations, including updating, creating, removing, sorting, and retrieving data objects by increasing the speed of these operations.

The disclosed system may further be integrated into an additional practical application of improving a computer system associated with the high-grade data repository. For example, by reducing overhead in the high-grade data repository, the processing and memory resources associated with the high-grade data repository do not need to maintain, process, and keep track of the overhead data. Thus, the processing and memory resources of the computer system associated with the high-grade data repository are utilized more efficiently.

The disclosed system may further be integrated into an additional practical application of improving the performance of the high-grade data repository. For example, the disclosed system is configured to denormalize a schema of the data objects stored in the high-grade data repository. The disclosed system denormalizes the schema of a particular data object by creating a single data table that includes the particular data object and different data objects that historically have been requested to be retrieved along with the particular data object. As new query statements are received, if the newly requested data objects are stored in the high-grade data repository or moved to the high-grade data repository from the low-grade data repository, the disclosed system may denormalize the schema of the newly requested data objects, and add them to the single data table that includes denormalized data objects. The disclosed system may execute the query statements by retrieving the requested denormalized data objects from the single data table.

Thus, in this manner, the disclosed system further improves the retrieval speed of the requested denormalized data objects because the disclosed system does not need to search through various data tables, find the requested data objects in different data tables, and join them to produce a result set. Rather, the disclosed system can retrieve the denormalized data objects from the single data table that includes the denormalized data objects.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to optimize the storage capacity associated with a data repository based on the usage frequency of data objects;

FIG. 2 illustrates an example operational flow of the system of FIG. 1 to optimize the storage capacity associated with a data repository based on the usage frequency of data objects; and

FIG. 3 illustrates an example flowchart of a method to optimize the storage capacity associated with a data repository based on the usage frequency of data objects.

### DETAILED DESCRIPTION

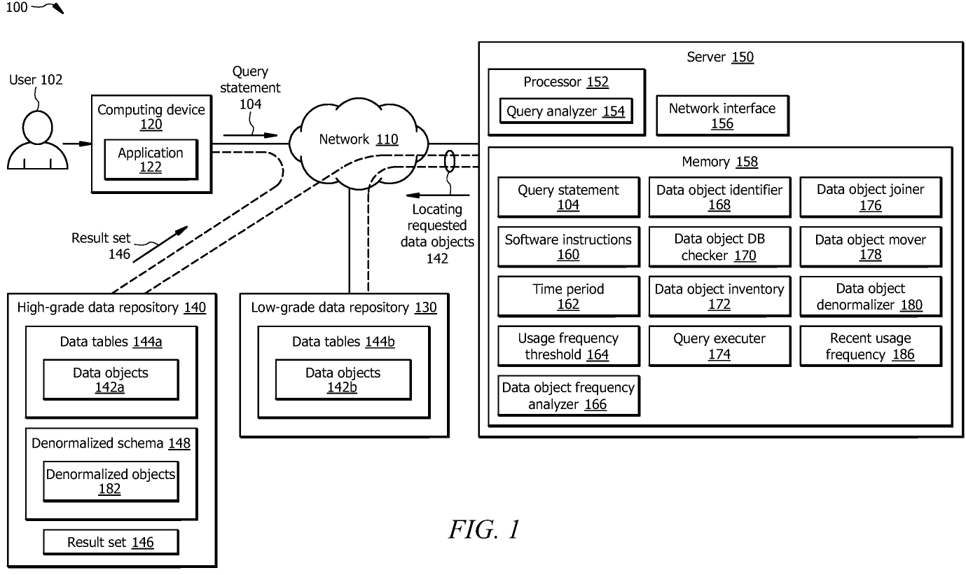

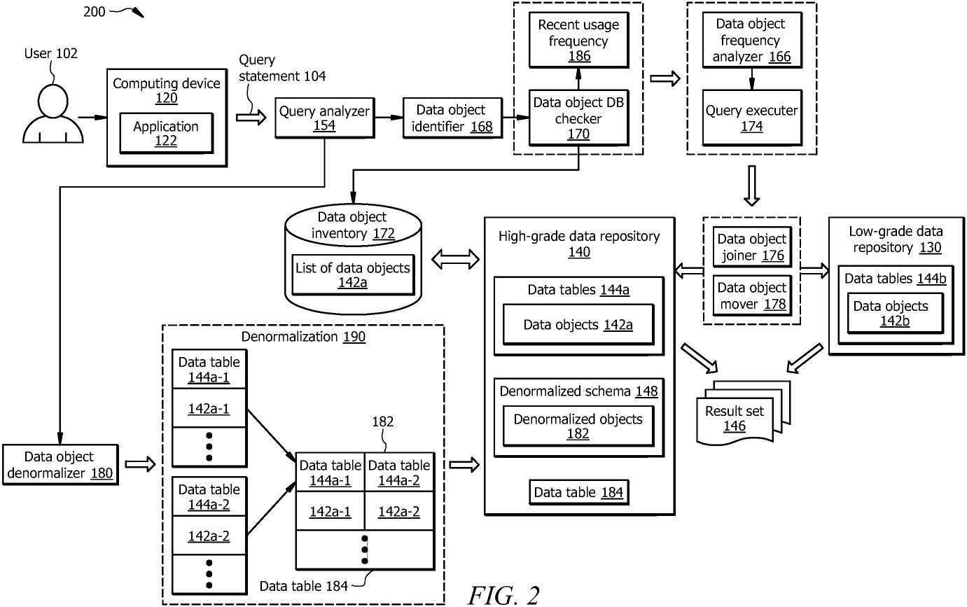

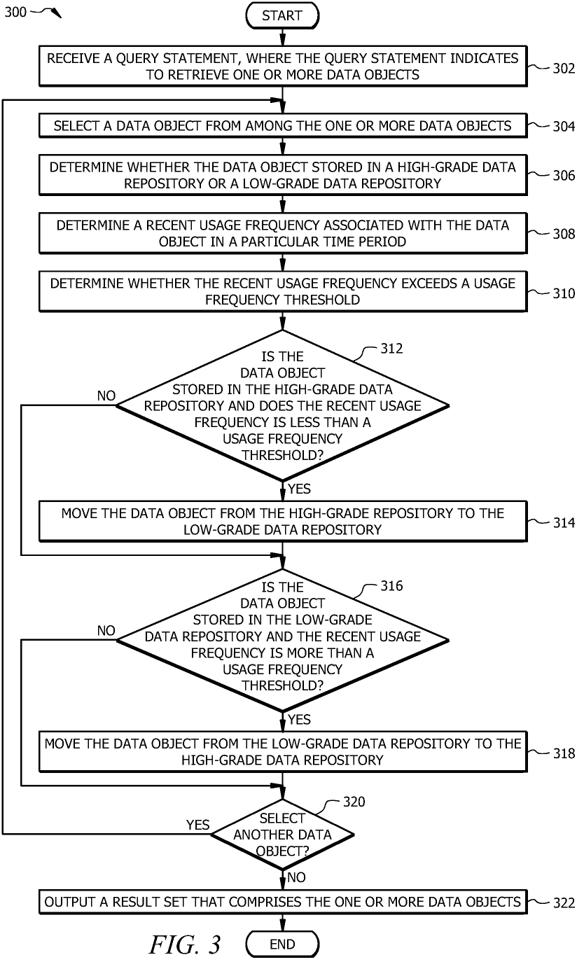

As described above, previous technologies fail to provide efficient and reliable solutions to optimize the storage capacity associated with data repositories based on the usage frequency of data objects. This disclosure provides various systems and methods to optimize the storage capacity associated with a data repository based on the usage frequency of data objects. In one embodiment, a system 100 for optimizing the storage capacity associated with the data repository based on the usage frequency of data objects is described in FIG. 1. In one embodiment, the operational flow 200 of system 100 is described in FIG. 2. In one embodiment, method 300 for optimizing the storage capacity associated with a data repository based on the usage frequency of data objects is described in FIG. 3.

### Example System for Data Warehouse Storage Capacity Optimization Based on Usage Frequency of Data Objects

FIG. 1 illustrates one embodiment of a system 100 that is configured to optimize storage capacity associated with a high-grade data repository 140 based on the usage frequency of data objects 142. In one embodiment, system 100 comprises a server 150. In some embodiments, system 100 further comprises a network 110, a computing device 120, a low-grade data repository 130, and a high-grade data repository 140. Network 110 enables the communication between components of the system 100. Server 150 comprises a processor 152 in signal communication with a memory 158. Memory 158 stores software instructions 160 that when executed by the processor 152, cause the processor 152 to perform one or more functions described herein. For example, when the software instructions 160 are executed, the processor 152 executes a query analyzer 154 to determine whether a recent usage frequency 186 associated with a first data object 142a within a particular time period 162 exceeds a usage frequency threshold 164, and if it is determined that the recent usage frequency 186 associated with the first data object 142a does not exceed a usage frequency threshold 164, the query analyzer 154 moves the first data object 142a from the high-grade data repository 140 to the low-grade data repository 130. In another example, the query analyzer 154 determines whether a recent usage frequency 186 associated with a second data object 142b within the particular time period 162 exceeds the usage frequency threshold 164, and if it is determined that the recent usage frequency 186 associated with the second data object 142b exceeds the usage frequency threshold 164, the query analyzer 154 moves the second data object 142b from the low-grade data repository 130 to the high-grade data repository 140. In other embodiments, system 100 may not have all of the components listed and/or may have other elements instead of, or in addition to, those listed above.

### System Components

Network 110 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 110 may be configured to support any suitable type of communication protocol as would be appreciated by one of ordinary skill in the art.

Computing device 120 is generally any device that is configured to process data and interact with users 102. Examples of the computing device 120 include, but are not limited to, a personal computer, a desktop computer, a workstation, a server, a laptop, a tablet computer, a mobile phone (such as a smartphone), etc. The computing device 120 may include a user interface, such as a display, a microphone, keypad, or other appropriate terminal equipment usable by user 102. The computing device 120 may include a hardware processor, memory, and/or circuitry configured to perform any of the functions or actions of the computing device 120 described herein. For example, a software application designed using software code may be stored in the memory and executed by the processor to perform the functions of the computing device 120. The system 100 may include any number of computing devices 120. For example, system 100 may include multiple computing devices 120 that are associated with an organization, where the server 150 is also associated with the same organization and is configured to oversee incoming and outgoing communications of the computing devices 120.

Application 122 may be a software, web, and/or mobile application 122 that a user 102 can interact with to input a query statement 104. For example, the query statement 104 may indicate to retrieve one or more data objects 142. In one example, the query statement 104 may be a Structured Query Language (SQL) statement 104.

The computing device 120 transmits the query statement 104 to the server 150 for processing. The query analyzer 154 receives and processes the query statement 104. This operation is described further below in conjunction with the operational flow of system 100.

Low-grade data repository 130 generally comprises any storage architecture. Examples of the low-grade data repository 130 include, but are not limited to, low-speed archival storage, a file storage system, a memory disk, a storage server, and a storage assembly directly (or indirectly) coupled to one or more components of the system 100. The low-grade data repository 130 may be used to store data tables 144b that include data objects 142b that are rarely requested to be retrieved (and/or used). In other words, the low-grade data repository 130 may store data objects 142b whose recent usage frequency 186 (and/or retrieval request frequency) in the particular time period 162 is less than the threshold 164.

The recent usage (and/or retrieval request) frequency 186 associated with the data object 142 may be determined based on the historical query statements 104. For example, if a particular data object 142 is requested to be retrieved fifty times as indicated in the historical query statements 104 in the particular time period 162, it is determined that the recent usage (and/or retrieval request) frequency 186 associated with the particular data object 142 is fifty. The particular time period 162 may be any time period, configured by an operator. For example, the time period 162 maybe two days, one week, two months, two years, etc. The threshold 164 may be any value, configured by an operator. For example, the threshold 164 maybe ten, twenty, fifty, eight, etc.

High-grade data repository 140 generally comprises any storage architecture. Examples of the high-grade data repository 140 include, but are not limited to, a high-speed database, a data warehouse, a network-attached storage cloud, a storage area network, and a storage assembly directly (or indirectly) coupled to one or more components of the system 100. The high-grade data repository 140 may be used to store data tables 144a that stores data objects 142a that are regularly requested to be retrieved (and/or used). In other words, the high-grade data repository 140 may store data objects 142a whose recent usage (and/or retrieval request) frequency 186 in the particular time period 162 is more than the usage frequency threshold 164. The high-grade data repository 140 may also store denormalized schema 148, denormalized data objects 182, and the result set 146. These items are described in conjunction with the operational flow 200 of system 100 described in FIG. 2.

The high-grade data repository 140 may be associated with a processing resource, such as a Central Processing Unit (CPU) that is capable of retrieving data objects 142 faster than the low-grade data repository 130. For example, the high-grade data repository 140 may be associated with a processing resource that is capable of processing a first number of instructions per second (e.g., 2000 instructions per second). The low-grade data repository 130 is associated with a processing resource, such as a CPU that is capable of processing a second number of instructions per second (e.g., 1000 instructions per second). Thus, database operation, including retrieving, sorting, creating, reading, updating, and deleting of data objects 142 by the high-grade data repository 140 may be performed faster than the low-grade data repository 130.

Thus, it is desired to optimize the storage capacity utilization of the high-grade data repository 140. For example, it is not desired to store rarely used data objects 142 in the high-grade data repository 140. System 100 (e.g., via the query analyzer 154) is configured to optimize the storage capacity utilization of the high-speed data repository 140 based on recent usage (and/or retrieval request) frequencies 186 of data objects 142. This process is described in more detail further below in operational flow 200 of the system 100 in FIG. 2.

### Server

Server 150 is generally a device that is configured to process data and communicate with computing devices (e.g., computing devices 120), databases (e.g., low-grade data repository 130, high-grade data repository 140), etc., via the network 110. The server 150 is generally configured to oversee the operations of the query analyzer 154, as described further below in conjunction with the operational flow 200 of system 100 described in FIG. 2 and method 300 described in FIG. 3.

Processor 152 comprises one or more processors operably coupled to the memory 158. The processor 152 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 152 may be a programmable logic device, a microcontroller, a microprocessor, or any suitable combination of the preceding. The one or more processors are configured to process data and may be implemented in hardware or software. For example, the processor 152 may be 8-bit, 16-bit, 32-bit, 64-bit, or of any other suitable architecture. The processor 152 may include an arithmetic logic unit (ALU) for performing arithmetic and logic operations, processor 152 registers the supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute instructions (e.g., software instructions 160) to implement the query analyzer 154. In this way, processor 152 may be a special-purpose computer designed to implement the functions disclosed herein. In an embodiment, the processor 152 is implemented using logic units, FPGAs, ASICs, DSPs, or any other suitable hardware. The processor 152 is configured to operate as described in FIGS. 1-3. For example, the processor 152 may be configured to perform one or more steps of method 300 as described in FIG. 3.

Network interface 156 is configured to enable wired and/or wireless communications (e.g., via network 110). The network interface 156 is configured to communicate data between the server 150 and other devices (e.g., computing devices 120), databases (e.g., low-grade data repository 130, high-grade data repository 140), systems, or domains. For example, the network interface 156 may comprise a WIFIinterface, a local area network (LAN) interface, a wide area network (WAN) interface, a modem, a switch, or a router. The processor 152 is configured to send and receive data using the network interface 156. The network interface 156 may be configured to use any suitable type of communication protocol as would be appreciated by one of ordinary skill in the art.

Memory 158 may be volatile or non-volatile and may comprise a read-only memory (ROM), random-access memory (RAM), ternary content-addressable memory (TCAM), dynamic random-access memory (DRAM), and static random-access memory (SRAM). Memory 158 may be implemented using one or more disks, tape drives, solid-state drives, and/or the like. Memory 158 is operable to store the query statement 104, software instructions 160, data object frequency analyzer 166, data object identifier 168, data object database (DB) checker 170, data object inventory 172, query executer 174, data object joiner 176, data object mover 178, data object denormalizer 180, and/or any other data or instructions. The software instructions 160 may comprise any suitable set of instructions, logic, rules, or code operable to execute the processor 152.

### Query Analyzer

Query analyzer 154 may be implemented by the processor 152 executing the software instructions 160, and is generally configured to optimize the storage capacity utilization associated with the high-grade data repository 140 and low-grade data repository 130.

In one embodiment, the query analyzer 154 may optimize the storage capacity utilization associated with the high-grade data repository 140 by moving data objects 142b stored in the high-grade data repository 140 that are rarely used (and/or requested to be retrieved less than the usage frequency threshold 164 based on historical query statements 104) to the low-grade data repository 130. The query analyzer 154 may also move data objects 142 stored in the low-grade data repository 130 that are often used (and/or requested to be retrieved more than the usage frequency threshold 164 based on historical query statements 104) to the high-grade data repository 140. In this manner, the query analyzer 154 may be configured to dynamically and physically toggle or move each data object 142 between the low-grade data repository 130 and high-grade data repository 140 based on its recent usage frequency 186.

The query analyzer 154 may execute the data object frequency analyzer 166 to determine the recent usage frequency 186 associated with a data object 142. The data object frequency analyzer 166 may be implemented by a machine learning algorithm. For example, the data object frequency analyzer 166 may comprise a support vector machine, neural network, random forest, k-means clustering, etc. The data object frequency analyzer 166 may be implemented by a plurality of neural network (NN) layers, Convolutional NN (CNN) layers, Long-Short-Term-Memory (LSTM) layers, Bi-directional LSTM layers, Recurrent NN (RNN) layers, and the like. In another example, the data object frequency analyzer 166 may be implemented by Natural Language Processing (NLP). In another example, the data object frequency analyzer 166 may be implemented by data feed processing, where the data may be in a form of text, code, among others.

The query analyzer 154 (e.g., via the data object frequency analyzer 166) may use the historical query statements 104 to determine the recent usage frequency 186 associated with each data object 142 that is requested to be retrieved in one or more historical query statements 104. In this process, the data object frequency analyzer 166 may perform a time-series analysis to determine how frequently a data object 142 is requested to be retrieved in the historical query statements 104. For example, the data object frequency analyzer 166 may record timestamps when query statements 104 are received. The data object frequency analyzer 166 may also identify data object(s) 104 that each query statement 104 indicated to be retrieved. In this manner, the data object frequency analyzer 166 may determine a recent usage frequency 186 associated with each data object 142 with respect to a particular time period 162.

The query analyzer uses this information to determine whether the recent usage frequency 186 associated with each data object 142 exceeds the usage frequency threshold 164. This process is described below in conjunction with the operational flow 200 of the system 100 described in FIG. 2.

The query analyzer 154 may be configured to execute one or more of the data object frequency analyzer 166, data object identifier 168, data object DB checker 170, data object inventory 172, query executer 174, data object joiner 176, data object mover 178, data object denormalizer 180, and/or any other software module.

Each of these components may be implemented in a software and/or a hardware module. For example, one or more of these components may be software code or instructions that are executed by the processor 152 and/or the query analyzer 154.

### Example Operational Flow for Storage Capacity Optimization Based on a Recent Data Object Usage Frequency

FIG. 2 illustrates an example operational flow 200 of system 100 of FIG. 1 to optimize a storage capacity utilization associated with the low-grade data repository 130 and high-grade data repository 140.

The operational flow 200 begins when the query analyzer 154 receives a query statement 104, for example, when the user 102 inputs the query statement 104 in the application 122, similar to that described in FIG. 1. The query statement 104 may indicate to retrieve one or more data objects 142.

### Identifying Data Objects Indicated in the Query Statement

The query analyzer 154 executes the data object identifier 168. The data object identifier 168 may include code that is configured to identify the one or more data objects 142 indicated in the query statement 104. In this process, the data object identifier 168 may be implemented by object-oriented programming, and configured to identify the one or more data objects 142 indicated in the query statement 104 as objects.

Upon identifying the one or more data objects 142, the query analyzer 154 determines whether each data object 142 from among the one or more data objects 142 is stored in the high-grade data repository 140.

To this end, the query analyzer 154 determines whether each data object 142 from among the one or more data objects 142 is stored in the data object inventory 172. The data object inventory 172 may include or be associated with a memory storage structure that is used to store the list of data objects 142a that are stored in the high-grade data repository 140. The query analyzer 154 may continuously, periodically (e.g., every five minutes, every hour, every day, etc.), or on-demand update and refresh the list of data objects 142a stored in the data object inventory 172 by checking if they are still stored in the high-grade data repository 140.

If the query analyzer 154 determines that a particular data object 142 from among the one or more data objects 142 (indicated in the query statement 104) is stored in the data object inventory 172, the query analyzer 154 determines that the particular data object 142 is available in the high-grade data repository 140. Otherwise, the query analyzer 154 determines that the particular data object 142 is stored in the low-grade data repository 130.

### Determining a Usage Frequency Associated With a Data Object

The query analyzer 154 determines the recent usage frequency 186 associated with each data object 142 indicated in the query statement 104. In this process, the query analyzer 154 may execute the data object frequency analyzer 166.

The query analyzer 154 (e.g., via the data object DB checker 170) determines the recent usage frequency 186 associated with each data object 142 indicated in the query statement 104 based on determining how many times each data object 142 has been requested in the historical query statements 104 in the particular time period 162. The query analyzer 154 feeds this information to the data object frequency analyzer 166.

Based on the recent usage frequency 186 associated with a particular data object 142, the data object frequency analyzer 166 can predict the trend in the future usage frequency associated with the particular data object 142, e.g., by performing a time-series analysis, similar to that described above in FIG. 1. For example, with respect to a first data object 142 (indicated in the query statement 104), the query analyzer 154 determines whether the first data object 142 is stored in the high-grade data repository 140 or the low-grade data repository 130, e.g., by executing the data object DB checker 170.

The query analyzer 154 determines the recent usage frequency 186 associated with the first data object 142. The query analyzer 154 determines whether the recent usage frequency 186 exceeds the usage frequency threshold 164.

If the query analyzer 154 determines that the first data object 142 is stored in the high-grade data repository 140, and that the recent usage frequency 186 associated with the first data object 142 does not exceed the usage frequency threshold 164, the query analyzer 154 physically moves the first data object 142 from the high-grade data repository 140 to the low-grade data repository 130, e.g., by executing the data object mover 178.

If the query analyzer 154 determines that the first data object 142 is stored in the low-grade data repository 130, and that the recent usage frequency 186 associated with the first data object 142 exceeds the usage frequency threshold 164, the query analyzer 154 physically moves the first data object t142 from the low-grade data repository 130 to the high-grade data repository 140, e.g., by executing the data object mover 178.

### Outputting the Result Set

In a first case, assume that the query statement 104 indicates to retrieve a first data object 142 and a second data object 142. Also, assume that the first and second data objects 142 are stored in the high-grade data repository 140. In this case, the query analyzer 154 produces the result set 146 that comprises the first and second data objects 142, e.g., by executing the query executer 174.

In a second case, assume that the first data object 142 is stored in the high-grade data repository 140, and the second data object 142 is stored in the low-grade data repository 130. The query analyzer 154 joins the first data object 142 with the second data object 142, e.g., by executing the data object joiner 176. In this process, the query analyzer 154 creates a data table 144 that comprises the first data object 142 and the second data object 142. In one embodiment, the query analyzer 154 may store the data table 144 in the high-grade data repository 140 if the query analyzer 154 determines that the recent usage frequencies 186 associated with the first and second data objects 142 are more than the usage frequency threshold 164.

In one embodiment, the query analyzer 154 may store the data table 144 in the low-grade data repository 130 if the query analyzer 154 determines that the recent usage frequencies 186 associated with the first and second data objects 142 are less than the usage frequency threshold 164. Upon joining the first and second data objects 142, the query analyzer 154 produces the result set 146 that includes the joined first and second data objects 142.

In a third case, assume that the first data object 142 is stored in the high-grade data repository 140, and the second data object 142 is stored in the low-grade data repository 130. Also, assume that the query analyzer 154 (e.g., via the data object frequency analyzer 166) determines that the recent usage frequency 186 associated with the second data object 142 is increasing over time, e.g., in the past time period 162 as indicated in the historical query statements 104. Based on the historical query statements 104 and recent usage frequency 186 associated with the second data object 142, the query analyzer 154 predicts whether the usage frequency of the second data object 142 will increase to exceed the usage frequency threshold 164 (and/or the usage frequency of the second data object 142 exceeds the usage frequency threshold 164).

If the query analyzer 154 predicts that the usage frequency of the second data object 142 will increase to exceed the usage frequency threshold 164 (and/or the usage frequency of the second data object 142 exceeds the usage frequency threshold 164), the query analyzer 154 physically moves the second data object 142 from the low-grade data repository 130 to the high-grade data repository 140.

In a fourth case, assume that the first data object 142 is stored in the high-grade data repository 140, and the second data object 142 is stored in the low-grade data repository 130. Also, assume that the query analyzer 154 (e.g., via the data object frequency analyzer 166) determines that the recent usage frequency 186 associated with the first data object 142 is decreasing over time, e.g., in the past time period 162 as indicated in the historical query statements 104.

Based on the historical query statements 104 and recent usage frequency 186 associated with the first data object 142, the query analyzer 154 predicts whether the usage frequency of the first data object 142 will decrease to become less than the usage frequency threshold 164 (and/or the usage frequency of the first data object 142 is less than the usage frequency threshold 164).

If the query analyzer 154 predicts that the usage frequency of the first data object 142 will decrease to become less than the usage frequency threshold 164 (and/or the usage frequency of the first data object 142 is less than the usage frequency threshold 164), the query analyzer 154 physically moves the first data object 142 from the high-grade data repository 140 to the low-grade data repository 130.

### Denormalizing a Schema Associated With a Data Object

In one embodiment, the query analyzer 154 is configured to denormalize a schema associated with a data object 142. Generally, a denormalized schema 148 may be referred to as a flattened schema. A data object 142 with a denormalized schema 148 means the data object 142 has not been reduced to relational database fields and tables. Denormalization is the process of adding precomputed redundant data to an otherwise normalized relational database to improve the read and retrieval performance of the database. Normalizing a database involves removing redundancy so only a single copy exists of each piece of information. Denormalizing a database requires data has first been normalized. The process of denormalizing a schema of a data object 142 is described below.

For example, assume that the query analyzer 154 receives a query statement 104, similar to that described above. Also, assume that the query analyzer 154 indicates to retrieve a first data object 142. The query analyzer 154 determines whether the first data object 142 is stored in the high-grade data repository 140 or the low-grade data repository 130, e.g., by executing the data object DB checker 170 and checking if the first data object 142 is stored in the data object inventory 172, similar that that described above. For example, assume that the first data object 142 is found in the high-grade data repository 140.

The query analyzer 154 determines whether the data object 142 is associated with the denormalized schema 148. If the query analyzer 154 determines that the first data object 142 is not associated with the denormalized schema 148, the query analyzer 154 denormalizes the schema associated with the first data object 142. In this process, to denormalize the schema associated with the first data object 142, the query analyzer 154 may add the first data object 142 and other data objects 142 that are historically used to be retrieved with the first data object 142 in a particular data table, such that j oining different data objects 142 from different data tables 144 is not required.

In one embodiment, upon receiving a query statement 104 that indicates to retrieve two data objects 142 from different data tables 144, these data objects 142 are joined together temporarily to be included in the result set 146. After the result set 146 is sent to the user 102, the joined data objects 142 may be separated and remain in their respective data tables 144.

If the query analyzer 154 determines that the usage frequency 186 associated with the data objects 142 exceeds the usage frequency threshold 164, the query analyzer 154 moves the data objects 142 to the high-grade data repository 140, similar to that described above.

In some cases, the process of retrieving data objects 142 from different data tables 144 and joining those data objects 142 is time-consuming and slows down the retrieval process. Thus, the denormalization process may be used to increase the retrieval process with respect to the data objects 142 stored in the high-grade data repository 140. In the denormalization process, the query analyzer 154 executes the data object denormalizer 180. The data object denormalizer 180 may include software instructions executed by the processor 152 and/or the query analyzer 154. In the denormalization process, the query analyzer 154 may create a permanent data table 184 that includes the data objects 142 (e.g., requested in the query statement 104).

In the example of FIG. 2, the denormalization process 190 of the two data tables 144a-1 and 144a-2 is illustrated. Assume that the query analyzer 154 receives a query statement 104 that indicates to retrieve the data objects 142a-1 from the data table 144a-1 and data objects 142a-2 from the data table 144a-2. The query analyzer 154 determines whether the data objects 142a-1 and 142a-2 are stored in the high-grade data repository 140. If the query analyzer 154 determines that the data objects 142a-1 and 142a-2 are stored in the high-grade data repository 140, the query analyzer 154 may perform the denormalization process 190.

For example, assume that the data objects 142a-1 and 142a-2 have been requested to be retrieved more than the usage frequency threshold 164, and the query analyzer 154 has stored these data objects 142a-1 and 142a-2 in the high-grade data repository 140. In the denormalization process 190, the query analyzer 154 combines the data table 144a-1 that includes the data objects 142a-1 with the data table 144a-2 that includes the data objects 142a-2. The result of the denormalization process 190 is the data table 184 that includes the combined data tables 144a-1 and 144a-2. The data table 184 may also include dependencies and redundant data objects 142 that are determined to be associated with the data objects 142a-1 and 142a-2. The combined data objects 142a-1 and 142a-2 and other redundant data objects 142 may be referred to as denormalized data objects 182.

In one embodiment, the data table 184 may be a permanent data table, such that the query analyzer 154 may keep the data table 184 in the high-grade data repository 140, even after the data objects 142a-1 and 142a-2 are included in the result set 146 and sent to the user 102.

In one embodiment, the data table 184 may be a semi-permanent data table, such that if the query analyzer 154 determines that the usage frequencies of one or both of the data objects 142a-1 and 142a-2 are decreasing over time (and/or have become less than the usage frequency threshold 164), the query analyzer 154 may separate the data table 184, and move a data object 142 whose usage frequency has become less than the usage frequency threshold 164 to the low-grade data repository 130, and normalize the schema of the data object 142 by removing the other data objects 142 that are historically used to be retrieved with the first data object from the data table 184, similar to that described above.

Upon denormalizing the data objects 142a-1 and 142a-2, and producing the denormalized data objects 182, the query analyzer 154 may include the denormalized data objects 182 in the result set 146 to be sent to the user 102.

The query analyzer 154 may continue to denormalize other data objects 142, and thus produce more denormalized data objects 182 and grow the data table 184. In this manner, since all the required data objects 182 are denormalized, i.e., stored in a single data table 184, the query analyzer 154 does not need to join the different data objects 142 from different data tables 144. This increases the speed of the retrieval process of the denormalized data objects 182 from the high-speed data repository 140.

Thus, if the data object 142 is requested to be retrieved in a future query statement 104 (e.g., second, third, etc., query statement 104), the query analyzer 154 may fetch the denormalized data object 182 that corresponds to the requested data object 142 associated with the denormalized schema 148.

In a similar manner, if any data object 142 is requested to be retrieved in a future query statement 104 (e.g., second, third, etc., query statement 104), the query analyzer 154 may fetch the requested combination of denormalized data objects 182 that correspond to the requested data objects 142 associated with the denormalized schema 148.

### Example Method for Storage Capacity Optimization Based on a Recent Data Object Usage Frequency

FIG. 3 illustrates an example flowchart of a method 300 for optimizing storage capacity of the high-grade data repository 140 based on recent usage frequency 186 associated with data objects 142. Modifications, additions, or omissions may be made to method 300. Method 300 may include more, fewer, or other steps. For example, steps may be performed in parallel or in any suitable order. While at times discussed as the system 100, processor 152, query analyzer 154, or components of any of thereof performing steps, any suitable system or components of the system may perform one or more steps of the method 300. For example, one or more steps of method 300 may be implemented, at least in part, in the form of software instructions 160 of FIG. 1, stored on non-transitory, tangible, machine-readable media (e.g., memory 158 of FIG. 1) that when run by one or more processors (e.g., processor 152 of FIG. 1) may cause the one or more processors to perform steps 302-322.

Method 300 begins at step 302 where the query analyzer 154 receives a query statement 104, where the query statement 104 indicates to retrieve one or more data objects 142. For example, the query analyzer 154 may receive the query statement 104 from computing device 120 when the user 102 inputs the query statement 104, similar to that described in FIGS. 1 and 2.

At step 304, the query analyzer 154 selects a data object 142 from among the one or more data objects 142. The query analyzer 154 may iteratively select a data object 142 until no data object 142 is left for evaluation.

At step 306, the query analyzer 154 determines whether the data object 142 is stored in the high-grade data repository 140 or low-grade data repository 130, for example, by executing the data object DB checker 170, similar to that described in FIGS. 1 and 2.

At step 308, the query analyzer 154 determines the recent usage frequency 186 associated with the data object 142 in a particular time period 162. In this process, the query analyzer 154 may determine the recent usage frequency 186 associated with the data object 142 based on analyzing historical query statements 104 and their timestamps and determining how many times the data object 142 has been requested to be retrieved in the particular time period 162.

At step 310, the query analyzer 154 determines whether the recent usage frequency 186 associated with the data object 142 exceeds the usage frequency threshold 164.

At step 312, the query analyzer 154 determines whether the data object 142 is stored in the high-grade data repository 140, and whether the recent usage frequency 186 associated with the data object 142 is less than the usage frequency threshold 164. If the query analyzer 154 determines that the data object 142 is stored in the high-grade data repository 140, and that the recent usage frequency 186 associated with the data object 142 is less than the usage frequency threshold 164, method 300 proceeds to step 314. Otherwise, method 300 proceeds to step 316.

At step 314, the query analyzer 154 moves the data object 142 from the high-grade data repository 140 to the low-grade data repository 130. For example, the query analyzer 154 physically moves the data object 142 to the low-grade data repository 130, similar to that described in FIGS. 1 and 2.

At step 316, the query analyzer 154 determines whether the data object 142 is stored in the low-grade data repository 130 and whether the recent usage frequency 186 associated with the data object 142 is more than the usage frequency threshold 164. If the query analyzer 154 determines that the data object 142 is stored in the low-grade data repository 130 and that the recent usage frequency 186 associated with the data object 142 is more than the usage frequency threshold 164, method 300 proceeds to step 318. Otherwise, method 300 proceeds to step 320.

At step 318, the query analyzer 154 physically moves the data object 142 from the low-grade data repository 130 to the high-grade data repository 140, similar to that described in FIGS. 1 and 2.

At step 320, the query analyzer 154 determines whether to select another data object 142. The query analyzer 154 determines to select another data object 142 if at least one data object 142 is left for evaluation.

At step 322, the query analyzer 154 outputs a result set 146 that comprises the one or more data objects 142 by retrieving the one or more data objects 142 from one or both of the low-grade data repository 130 and the high-grade data repository 140. For example, the query analyzer 154 may join requested data objects 142 stored in the low-grade data repository 130 with requested data objects 142 stored in the high-grade data repository 140.

In some embodiments, method 300 may include one or more additional steps to perform the denormalization process 190, similar to that described in FIG. 2.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words "means for" or "step for" are explicitly used in the particular claim.

1. A system for optimizing memory utilization based on the usage frequency of data objects comprising:
a processor configured to:
receive a query statement, wherein the query statement indicates to retrieve one or more data objects;
for a first data object from among the one or more data objects:
determine whether the first data object is stored in a high-grade data repository or a low-grade data repository;
determine a first recent usage frequency associated with the first data object in a particular time period;
determine whether the first recent usage frequency exceeds a usage frequency threshold;
in response to determining that the first data object is stored in the high-grade data repository and that the first recent usage frequency does not exceed the usage frequency threshold, move the first data object from the high-grade data repository to the low-grade data repository;
in response to determining that the first data object is stored in the low-grade data repository and that the first recent usage frequency exceeds the usage frequency threshold, move the first data object from the low-grade data repository to the high-grade data repository; and
output a result set that comprises the one or more data objects by retrieving the one or more data objects from one or both of the low-grade data repository and the high-grade data repository;
a memory, operably coupled with the processor, and operable to store the query statement;
the low-grade data repository, communicatively coupled with the processor and the memory, and configured to store data objects associated with usage frequencies less than the usage frequency threshold; and the high-grade data repository, communicatively coupled with the processor, the memory, and the low-grade data repository, and configured to store data objects associated with usage frequencies more than the usage frequency threshold.

2. The system of claim 1, wherein:
the high-grade data repository is associated with a first processing resource that is capable of processing a first number of instructions per second;
the low-grade data repository is associated with a second processing resource that is capable of processing a second number of instructions per second; and
the first number of instructions is more than the second number of instructions.

3. The system of claim 1, wherein:
the query statement indicates to retrieve the first data object and a second data object;
outputting the result set comprises:
determining that the first data object is stored in the high-grade data repository;
determining that the second data object is stored in the low-grade data repository; and
in response to determining that the first data object is stored in the high-grade data repository and the second data object is stored in the low-grade data repository, joining the first data object with the second data object, wherein joining the first data object with the second data object comprises creating a data table that comprises the first data object and the second data object.

4. The system of claim 3, wherein the processor is further configured to:
determine whether a second recent usage frequency associated with the second data object exceeds the usage frequency threshold; and in response to determining that the second recent usage frequency associated with the second data object exceeds the usage frequency threshold, move the second data object from the low-grade data repository to the high-grade data repository.

5. The system of claim 1, wherein the processor is further configured to:
in response to moving the first data object to the high-grade data repository, determine whether the first data object is associated with a denormalized schema; and
in response to determining that the first data object is not associated with the denormalized schema, denormalize a first schema of the first data object, wherein denormalizing the first schema corresponds to adding the first data object and other data objects that are historically used to be retrieved with the first data object in a particular data table, such that j oining different data objects from different data tables is not required.

6. The system of claim 5, wherein the processor is further configured to:
after demoralizing the first schema, determine whether a third recent usage frequency associated with the first data object exceeds the usage frequency threshold;
in response to determining that the third recent usage frequency does not exceed the usage frequency threshold:
normalize the first schema by removing the other data objects that are historically used to be retrieved with the first data object from the particular data table; and
move the first data object from the high-grade data repository to the low-grade data repository.

7. The system of claim 1, wherein determining whether the first recent usage frequency exceeds the usage frequency threshold comprises determining whether the first data object has been requested to be retrieved in historical query statements in the particular time period more than the usage frequency threshold.

8. A method for optimizing memory utilization based on the usage frequency of data objects comprising:
receiving a query statement, wherein the query statement indicates to retrieve one or more data objects;
for a first data object from among the one or more data objects:
determining whether the first data object is stored in a high-grade data repository or a low-grade data repository;
determining a first recent usage frequency associated with the first data object in a particular time period;
determining whether the first recent usage frequency exceeds a usage frequency threshold;
in response to determining that the first data object is stored in the high-grade data repository and that the first recent usage frequency does not exceed the usage frequency threshold, moving the first data object from the high-grade data repository to the low-grade data repository;
in response to determining that the first data object is stored in the low-grade data repository and that the first recent usage frequency exceeds the usage frequency threshold, moving the first data object from the low-grade data repository to the high-grade data repository; and
outputting a result set that comprises the one or more data objects by retrieving the one or more data objects from one or both of the low-grade data repository and the high-grade data repository.

9. The method of claim 8, wherein:
the high-grade data repository is associated with a first processing resource that is capable of processing a first number of instructions per second;
the low-grade data repository is associated with a second processing resource that is capable of processing a second number of instructions per second; and the first number of instructions is more than the second number of instructions.

10. The method of claim 8, wherein:
the query statement indicates to retrieve the first data object and a second data object;
outputting the result set comprises:
determining that the first data object is stored in the high-grade data repository;
determining that the second data object is stored in the low-grade data repository; and
in response to determining that the first data object is stored in the high-grade data repository and the second data object is stored in the low-grade data repository, joining the first data object with the second data object, wherein joining the first data object with the second data object comprises creating a data table that comprises the first data object and the second data object.

11. The method of claim 10, further comprising:
determining whether a second recent usage frequency associated with the second data object exceeds the usage frequency threshold; and
in response to determining that the second recent usage frequency associated with the second data object exceeds the usage frequency threshold, moving the second data object from the low-grade data repository to the high-grade data repository.

12. The method of claim 8, further comprising:
in response to moving the first data object to the high-grade data repository, determining whether the first data object is associated with a denormalized schema; and
in response to determining that the first data object is not associated with the denormalized schema, denormalizing a first schema of the first data object, wherein denormalizing the first schema corresponds to adding the first data object and other data objects that are historically used to be retrieved with the first data object in a particular data table, such that joining different data objects from different data tables is not required.

13. The method of claim 12, further comprising:
after demoralizing the first schema, determining whether a third recent usage frequency associated with the first data object exceeds the usage frequency threshold;
in response to determining that the third recent usage frequency does not exceed the usage frequency threshold:
normalizing the first schema by removing the other data objects that are historically used to be retrieved with the first data object from the particular data table; and
moving the first data object from the high-grade data repository to the low-grade data repository.

14. The method of claim 8, wherein determining whether the first recent usage frequency exceeds the usage frequency threshold comprises determining whether the first data object has been requested to be retrieved in historical query statements in the particular time period more than the usage frequency threshold.

15. A computer program comprising executable instructions stored in a non-transitory computer-readable medium that when executed by a processor causes the processor to:
receive a query statement, wherein the query statement indicates to retrieve one or more data objects;
for a first data object from among the one or more data objects:
determine whether the first data object is stored in a high-grade data repository or a low-grade data repository;
determine a first recent usage frequency associated with the first data object in a particular time period;
determine whether the first recent usage frequency exceeds a usage frequency threshold;
in response to determining that the first data object is stored in the high-grade data repository and that the first recent usage frequency does not exceed the usage frequency threshold, move the first data object from the high-grade data repository to the low-grade data repository;
in response to determining that the first data object is stored in the low-grade data repository and that the first recent usage frequency exceeds the usage frequency threshold, move the first data object from the low-grade data repository to the high-grade data repository; and
output a result set that comprises the one or more data objects by retrieving the one or more data objects from one or both of the low-grade data repository and the high-grade data repository.

16. The computer program of claim 15, wherein:
the high-grade data repository is associated with a first processing resource that is capable of processing a first number of instructions per second;
the low-grade data repository is associated with a second processing resource that is capable of processing a second number of instructions per second; and
the first number of instructions is more than the second number of instructions.

17. The computer program of claim 15, wherein:
the query statement indicates to retrieve the first data object and a second data object;
outputting the result set comprises:
determining that the first data object is stored in the high-grade data repository;
determining that the second data object is stored in the low-grade data repository; and
in response to determining that the first data object is stored in the high-grade data repository and the second data object is stored in the low-grade data repository, joining the first data object with the second data object, wherein joining the first data object with the second data object comprises creating a data table that comprises the first data object and the second data object.

18. The computer program of claim 17, wherein the instructions when executed by the processor, further cause the processor to:
determine whether a second recent usage frequency associated with the second data object exceeds the usage frequency threshold; and
in response to determining that the second recent usage frequency associated with the second data object exceeds the usage frequency threshold, move the second data object from the low-grade data repository to the high-grade data repository.

19. The computer program of claim 15, wherein the instructions when executed by the processor, further cause the processor to:
in response to moving the first data object to the high-grade data repository, determine whether the first data object is associated with a denormalized schema; and
in response to determining that the first data object is not associated with the denormalized schema, denormalize a first schema of the first data object, wherein denormalizing the first schema corresponds to adding the first data object and other data objects that are historically used to be retrieved with the first data object in a particular data table, such that j oining different data objects from different data tables is not required.

20. The computer program of claim 19, wherein the instructions when executed by the processor, further cause the processor to:
after demoralizing the first schema, determine whether a third recent usage frequency associated with the first data object exceeds the usage frequency threshold;
in response to determining that the third recent usage frequency does not exceed the usage frequency threshold:
normalize the first schema by removing the other data objects that are historically used to be retrieved with the first data object from the particular data table; and
move the first data object from the high-grade data repository to the low-grade data repository.
